(19) United States
(12) Patent Application Publication
(10) Pub. No.: US 2026/0056809 A1
(43) Pub. Date: Feb. 26, 2026

(54) SCALABLE HARDWARE EVENT ROUTING IN AN EXPANDABLE SYSTEM

(71) Applicant: Keithley Instruments, LLC, Solon, OH (US)

(72) Inventors: Daniel Mesenger, Reminderville, OH (US); Dawson C. Green, Beaverton, OR (US)

(73) Assignee: Keithley Instruments, LLC, Solon, OH (US)

(21) Appl. No.: 19/289,316

(22) Filed: Aug. 4, 2025

Related U.S. Application Data
(60) Provisional application No. 63/685,166, filed on Aug. 20, 2024.

(51) Int. Cl. G06F 9/54; G06F 9/30; G06F 13/40

(52) U.S. Cl. CPC G06F 9/542; G06F 9/30098; G06F 13/4022

(57) ABSTRACT

A test and measurement device is described having one or more capture devices configured to receive an event from a respective event generator. The test and measurement device also includes a broadcaster configured to receive the event from the one or more capture devices and broadcast the event. The test and measurement device also includes one or more comparators configured to receive the event from the batch broadcaster and route the event to a respective event detector based on a comparison of an event identifier and a detector identifier.

### CROSS-REFERENCE TO RELATED APPLICATIONS

This application is a nonprovisional and claims benefit of U.S. Provisional Application No. 63/685,166, titled “SCALABLE HARDWARE EVENT ROUTING IN AN EXPANDABLE SYSTEM,” filed Aug. 20, 2024, the disclosure of which is incorporated herein by reference in their entirety.

### TECHNICAL FIELD

This disclosure relates to test and measurement instruments, and more particularly to a scalable hardware event routing in a test and measurement system.

### BACKGROUND

Some expandable test and measurement system architectures require an event routing solution that scales efficiently to a much larger system. Some expandable test and measurement system architectures include an interface and/or system that allows customers to describe a sequence of events that can interact with one or more instruments. An example of a sequence used on a source measure unit (SMU) can involve the following: (1) waiting for a rising edge on DIGIO Pin 1; (2) setting a source level for SMU channel 1 in slot1 of the SMU; (3) waiting for 100 us; and (4) measuring the current on SMU channel 1 in slot1 of the SMU.

This example sequence of events can be generalized into a generic system of “generators” and “detectors”. Generators are components in the system that can asynchronously generate a unique event. Detectors are components in the system that can be configured to wait on any unique event in the system. The challenge that has arose from some expandable test and measurement system architectures is two-fold. Firstly, some expandable test and measurement system architectures require a much larger number of generators and detectors. Secondly, some expandable test and measurement system architectures are meant to be modular, which requires the event to be scalable, both up and down, at runtime. Furthermore, in some examples, multiple modular and expandable test and system architectures can be chained together in a single system where events need to be routed from any one point in the system to any other point in the system.

Some event routing has been accomplished via a single multiplexer on a product. This multiplexer can be designed as one large switchboard. Any local detector on this switchboard can be connected to any local generator in the system via software. Once these connections between detector and generator are established, events are routed from generators to detectors solely in hardware, without software intervention. The implementation of this switchboard in hardware is a large multidimensional multiplexor. For example, for a local system having N generators and M detectors, each detector can be configured to listen to any generator. Because each detector can be configured to listen to any generator, every detector must pick one of N generators to connect to. The detector connection is implemented as an N-to-1 multiplexor. Generally, this type of multiplexor scales inefficiently as N grows. For example, a system including M number of detectors, accordingly, the example system needs a total of M N-to-1 multiplexors to realize the ability to fully route events throughout the example system. In conclusion, the primary problem with this example system implementation is that the hardware resources to implement the N-to-1 multiplexors scales poorly as the number of generators increases. Additionally, this large piece of hardware needs to be replicated once for each detector in the system. For an N by M system where N and M are similar in size, the growth rate in resources is roughly O(n2).

This solution is unacceptable for some expandable test and measurement system architectures due to the large number of generators and detectors in each local system and the fact that the implementation of event routing must now be distributed throughout hardware to allow for modularity and expandability. Such limitations means that a solution is needed to connect multiple local systems of generators and detectors together to allow routing between these distributed systems.

### BRIEF DESCRIPTION OF THE DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 is a diagram illustrating a local system for hardware event routing, according to some examples.

FIG. 2 is a flowchart illustrating the operations of the switch of FIG. 1, according to some examples.

FIG. 3 illustrates a larger system with two local systems connected in a symmetrical fashion, according to some examples.

FIG. 4 is a diagram illustrating a system with multiple local system, according to some examples.

To facilitate understanding, identical reference numerals have been used, where possible, to designate identical elements that are common to the figures. It is contemplated that elements of one example may be beneficially incorporated in other examples.

### DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the description or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Examples of the present disclosure provide a device, system, and method that can be used for scalable hardware event routing. Examples of the present disclosure involve a switch coupled to generators and detectors and configured to route hardware events from generators to detectors. The present disclosure involves breaking up a large total system into smaller local systems that can be connected in a dynamic fashion. A local system is defined simply as a collection of unique generators and detectors, and a configurable switch to connect detectors to generators. Generators are components in the system that can asynchronously generate a unique event. Detectors are components in the system that can be configured to wait on any unique event in the system.

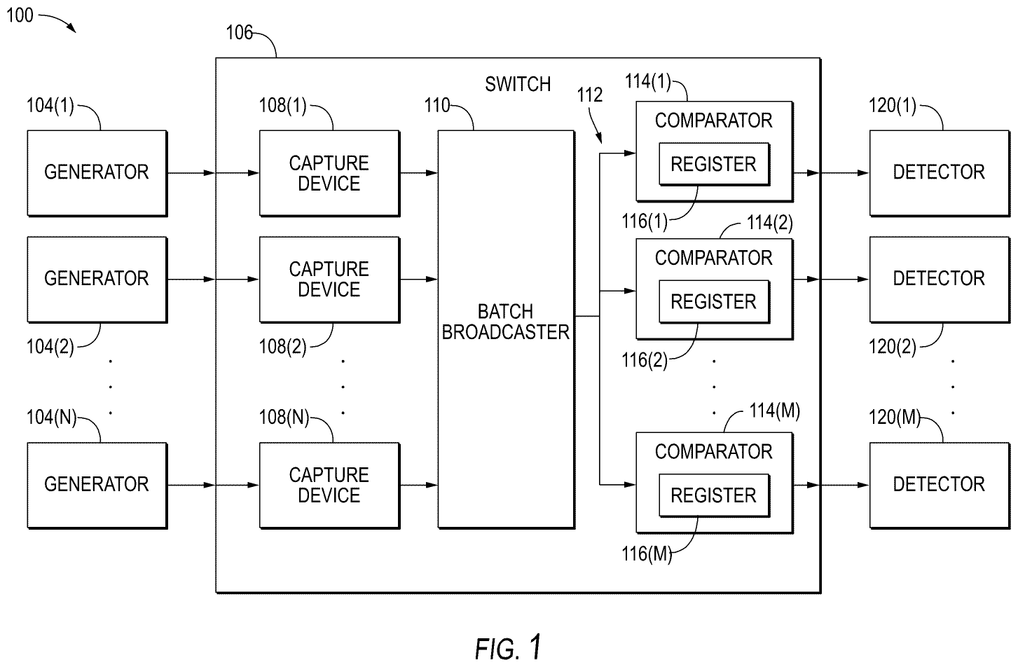

FIG. 1 is a diagram illustrating a local system for hardware event routing, according to some examples. As illustrated in FIG. 1, the system 100 includes generators 104, detectors 120, and a switch 106 that allows detectors 120 in the local system 100 to be configured by software to listen to any generator 104 in the local system 100. As illustrated in FIG. 1, the system 100 includes N generators 104 and M detectors 120; however, the system 100 can have any number of generators 104 and/or detectors 120. In some examples, the number of generators 104 of the system 100 is equal to the number of detectors 120, such that the system 100 includes a detector 120 for each generator 104. For the purposes of this discussion, description and/or references to generators 104 or a generator 104 (e.g., generator 104(1), generator 104(2), generator 104(N)) can apply to any of the generators 104, and description and/or references to detectors 120 or a detector 120 (e.g., detector 120(1), detector 120(2), detector 120(M)) can apply to any of the detectors 120. Each of the generators 104 is coupled to an input of the switch 106, and each of the detectors 120 is coupled to an output of the switch 106. Examples of a generator 104 can include, but are not limited to, edge detection on an external digital input pin (DIGIO), SMU output compliance detection, software initiated generic generators, and examples of a detector 120 can include, but are not limited to, edge generation on an external DIGIO pin, SMU measurement trigger, SMU source change trigger, and software controlled generic generators.

For a local system having N generators and M detectors, each detector 120 can be configured to listen to any generator 104. Because each detector 120 can be configured to listen to any generator 104, every detector 120 must pick one of N generators 104 to which to connect. Once a detector 120 in the local system 100 is configured to listen to a generator 104 in the local system 100, any time the generator 104 in the local system 100 generates an event, the switch 106 in the local system 100 routes that event to the detector 120 in the local system 100 to notify the detector 120 in the local system 100 that the event has occurred.

As stated earlier, the switch connecting generators and detectors can be a very large multiplexor that could simultaneously route any generator to any detector. Accordingly, such system requires a total of M N-to-1 multiplexors (in a system with N generators and M detectors) to be fully realized. In some examples, the switch can limit the number of events that can be routed in a given clock cycle to one single event. With a sufficiently fast clock, this limitation of number of events may not be noticeable to the user in most applications. By limiting the number of events that can be routed in a single clock cycle, in some examples, the system 100 can include a switch 106 that routes events in batches with a much smaller hardware resource cost.

FIG. 1 also shows details for the switch, according to the present disclosure. The switch 106 includes capture devices 108, a batch broadcaster 110, and comparators 114. As illustrated in FIG. 1, the system 100 includes N capture devices 108 and M comparators 114; however, the system 100 can have any number of capture devices 108 and/or comparators 114. In some examples, the number of capture devices 108 of the system 100 is equal to the number of generators 104, such that the system 100 includes a capture device for each generator 104. Similarly, the number of comparators 114 of the system 100 is equal to the number of detectors 120, such that the system 100 includes a comparator 114 for each detector 120. For the purposes of this discussion, description and/or references to a capture device 108 (e.g., capture device 108(1), capture device 108(2), capture device 108(N)) can apply to any of the capture devices 108, and description and/or references to a comparator 114 (e.g., comparator 114(1), comparator 114(2), comparator 114(M)) can apply to any of the comparators 114. Each of the capture devices 108 is coupled to an input of the switch 106 and an input of the batch broadcaster 110, and each of the comparators 114 is coupled to an output of the batch broadcaster 110 via a shared bus 112 and an output of the switch 106. Examples of a capture device 108 can include memory or logic resources. The capture blocks 108, the batch broadcaster 110, and/or the comparators 114 can be implemented in an FPGA via register transfer level (RTL) code. The switch 106 can include other components (not illustrated) needed to facilitate the operations of the switch 106, such as a processor and memory.

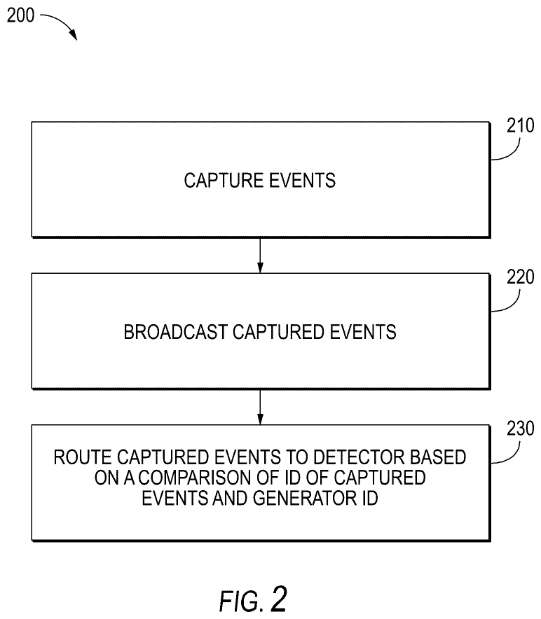

FIG. 2 is a flowchart illustrating the operations of the switch 106 of FIG. 1, according to some examples. As illustrated, operations 200 of the switch 106 of FIG. 1 can be described in three stages: stage 210, stage 220, and stage 230. Prior to the operations 200, the switch 106 is configured so that it can route events from the generators 104 of FIG. 1 to the detectors of 120. Such configuration of the switch 106 can include, but is not limited to, configuring the input and output ports of the switch 106, configuring the capture devices 108 to receive events, configuring the capture devices 108 to listen to a particular generator, configuring the batch broadcaster 110, configuring the comparators 114 to output to a particular detector, and configuring the clock speed of the switch 106. In some examples, the switch 106 operates based on a clock rate faster than the clock rate of the generators 104. In some examples, the switch 106 has a clock speed of the switch greater than the rate of events generated by the generators 104 or received by the switch 106. In further examples, the clock speed of the switch 106 is faster than the expected rate of event generation (10× or even 100×) to prevent event loss.

The first stage 210 of operation 200 of the switch 106 involves capturing events from the generators 104 as events occur. When events occur, the events pass from the generators 104 to the switch 106, and the capture devices 108 are configured to receive the events from the generators 104. During the first stage 210, the batch broadcaster 110 grabs captured events from the capture devices 108 and clears the captured events from the capture devices 108 any time the batch broadcaster 110 is not currently broadcasting events. In some examples, the events last for a single clock cycle. Accordingly, the capture devices 108 notice that the event has occurred and hold onto the event until the batch broadcaster 110 is able to handle the event. So when the batch broadcaster 110 handles the event, the batch broadcaster 110 clears the event(s) from the capture devices 108 so that the capture device(s) 108 is able to capture another event once again. When generators 104 create events that are passed to switch 106, the generators 104 include an identifier as a part of the event. Depending on the configuration of the switch 106, the identifier can indicate the destination detector or the originating generator.

Once the batch broadcaster 110 grabs these events, the switch 106 moves onto the second stage 220 of operations 200, in which the batch broadcaster 110 begins broadcasting the batch of events on a shared bus 112, one event at a time. In some examples, the batch broadcaster 110 broadcasts a compact encoding of the batch events, which includes a binary representation of the event identifier. In some examples, the batch broadcaster 110 is the middle of broadcasting a batch of events on the shared bus 112, and while the batch broadcaster 110 is broadcasting, the batch broadcaster 110 is still receiving events from the capture devices 108. Accordingly, the batch broadcaster 110 keeps track of the events received from the capture devices 108 while broadcasting 220. In some further examples, the batch broadcaster 110 keeps track of events in a queue or any other structure that can store events while the batch broadcaster 110 continues to transmit events to the comparators 114 via the shared bus 112. The events stored in the batch broadcaster 110 may be referred herein as a batch of events, and the batch of events can include any number of events. For a batch of events, the batch broadcaster 110 transmits each event of the batch of events to each comparator 114 (via broadcasting) one at a time per clock cycle.

During the third stage 230, the comparators 114 each receive the broadcasted event and compares the event bus to a programable register 116. Each comparator 114 has a programmable register 116 and is coupled to provide its output to the output of the switch 106 and to a detector 120. As illustrated in FIG. 1, the switch 106 has M comparators 114 and has M outputs with each output of the switch 106 coupled to a detector of the M detectors 120. Accordingly, each comparator 114 corresponds to one of the detectors 120, and consequently, because each detector 120 is configured to listen to a specific generator 104, the programmable register 116 of each comparator 114 is configured with an identifier that represents the generator 104 to which the detector 120 is listening.

When the batch broadcaster 110 broadcasts the event on the shared bus 112 to the comparators 114, the transmission/broadcast includes information regarding where the event originated (i.e., the generator 104 that created the event). In some examples, the information from where the event originated is an identifier that represents the generator 104. The comparator 114 detects the generator identifier and routes the event to that detector 120 listening to the generator associated with the generator ID. For example, the programmable register 116 of a comparator 114 can have the identifier value of 1, which corresponds to the generator identifier of a specific generator (e.g., generator 104(1)), and this comparator 114 is coupled to an output of the switch 106, which in turn is coupled to a detector configured to listen to the specific generator. Accordingly, when the event identifier broadcasted with the event matches the generator identifier stored in the programmable register 116 of the comparator 114, the comparator 114 allows the broadcasted event to pass through to the output of the switch 106, thereby during stage 230 routing the broadcasted event to a detector 120 specified by the event identifier.

The hardware resources required to implement this type of switch scales much more efficiently than the previous approaches. The number of resources required to implement this type of switch for a local system with N generators and M detectors is approximately M+ceil(log₂(M))*N. As previously considered for a product where N and M are similar in size, the growth rate of this implementation scales as O(n), which improves over the previous O(n²) scaling.

In some examples, the system 100 has a fixed number of unique generators 104 and detectors 120 that is determined by the hardware. However, connecting multiple local systems using the concept of bridge events can result in a much larger system at runtime.

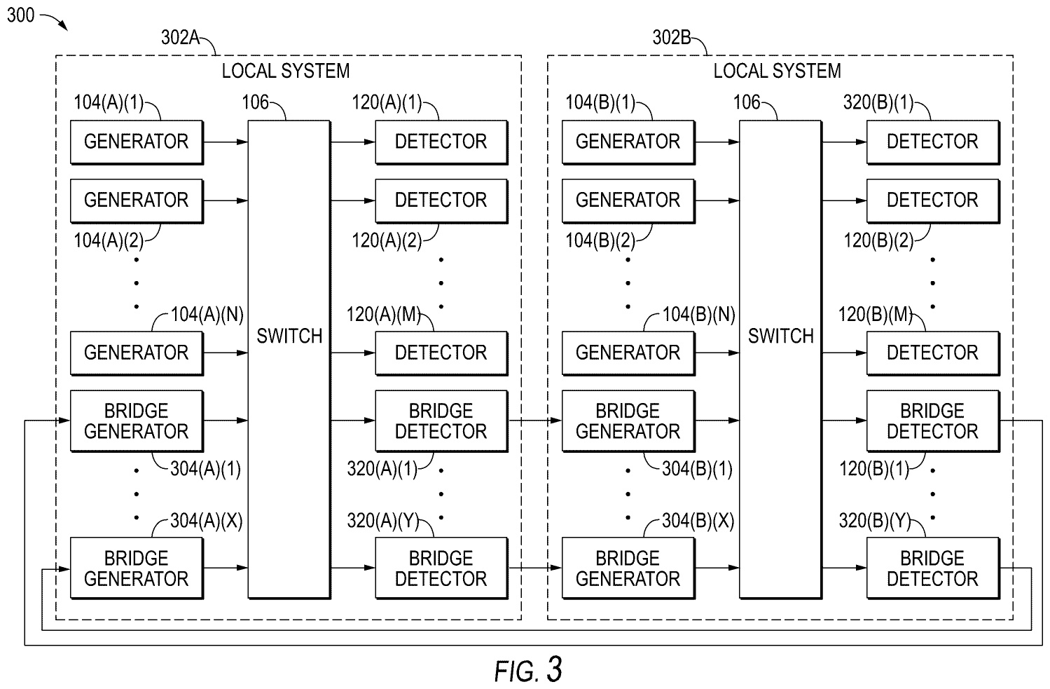

FIG. 3 illustrates a larger system with two local systems connected in a symmetrical fashion, according to some examples. A detector on local system B can be configured to listen to a generator on local system A by: (1) configuring a bridge event detector on local system A to listen to the generator of interest of local system A; and (2) configuring the detector of interest on local system B to listen to the paired bridge event generator on local system B. Bridge events can include event identifiers that are unique to a local system that are used to bridge an event from one local system to another local system somewhere else. The physical media used to transport the event from one physical location to the other is independent of the bridge event. An example of physical media can be TSP-Link, USB, or proprietary serial communications.

As illustrated in FIG. 3, system 300 comprises two local systems 302A and 302B. System 300 can include any number of local systems, and each of the local systems can be set up to accommodate for the number of local systems in the system 300. For the purposes of this discussion, description and/or references to local system 302 can refer to either local system 302A or local system 302B.

Each of the local systems 302 have a switch 106, generators 104, and detectors 120. As illustrated in FIG. 3, each of the local systems 302 includes N generators 104 and M detectors 120; however, the local systems 302 can have any number of generators 104 and/or detectors 120. Each of the local systems 302 further have a bridge generator 304 and a bridge detector 320; that is, local system 302A has bridge generator 304(A) and bridge detector 320(A), and local system 302B has bridge generator 304(B) and bridge detector 320(B). As illustrated in FIG. 3, the system 300 includes X bridge generators 304 and Y bridge detectors 320; however, each of the local systems 302 can have any number of bridge generators 304 and/or bridge detectors 320. For the purposes of this discussion, description and/or references to bridge generator 304 and/or bridge detector 320 can refer to any of the bridge generators 304 of local system 302A and local system 302B and/or bridge detectors 320 of local system 302A and local system 302B, respectively. Each bridge generator 304 and bridge detector 320 is paired with a bridge detector 320 or bridge generator 304 in the connecting system. For example, bridge generator 304(A)(1) of local system 302A is paired to bridge detector 320(B)(1) of local system 302B.

Each local system 302 is aware of the unique event identifiers that are defined for its own system. In this example, the event routing hardware on local system 302B does not need any information about local system 302A, but a detector 120 on local system 302B can be notified that an event on local system 302A has occurred (i.e., generator 304 in local system 302 has generated an event).

When connecting local systems together, the number of bridge events do not need to be symmetrical. That is, in some example, bridge events can occur any combination of the local systems. For example, local system 302A can generate all of the bridge events, and local system 302B can generate no bridge events. With two local systems coupled together, as long as each local system provides bridge events to another system, events can be routed from one local system to any other local system by using bridge events.

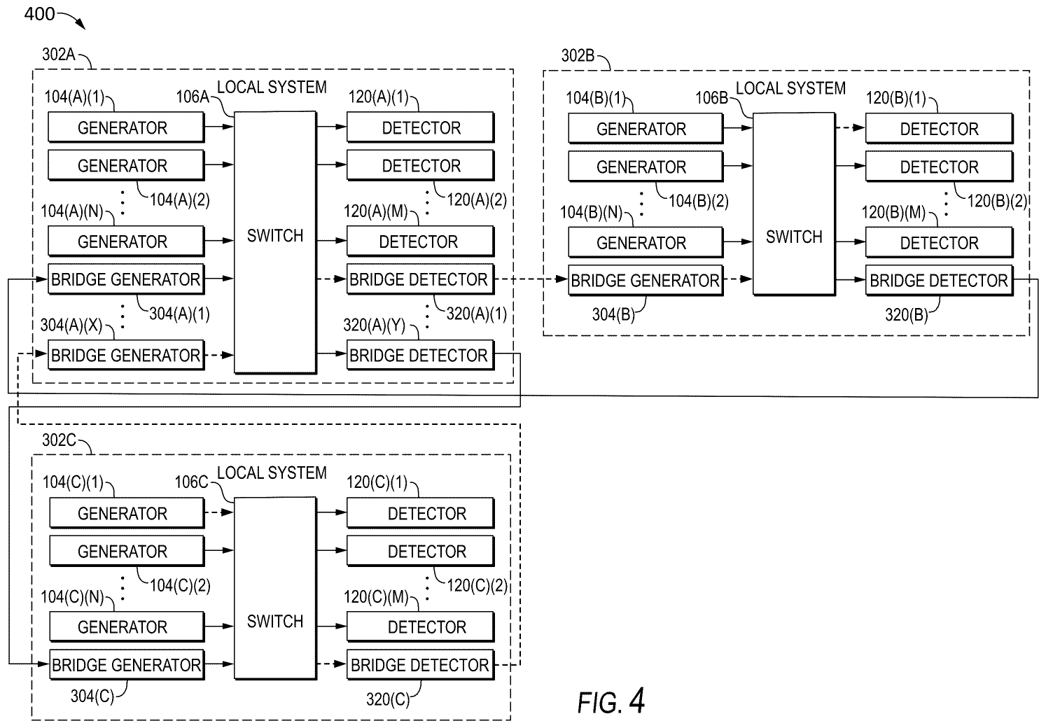

FIG. 4 is a diagram illustrating a system with multiple local system, according to some examples. Specifically, FIG. 4 shows how a detector on local system B can be notified of an event that occurred on local system C. As illustrated in FIG. 4, system 400 includes local system 302A, 302B, 302C. Like with FIG. 3, for the purposes of this discussion, description and/or references to local system 302 can refer to local system 302A, local system 302B, or local system 302C. Each of the local systems 302 have a switch 106, generators 104, and detectors 120. As illustrated in FIG. 4, like with system 100 and system 300, the system 400 can have any number of generators 104 and/or detectors 120; however, for illustrative purposes, the local systems 302 includes N generators 104 and M detectors 120. Each of the local systems 302 further can have any number of bridge generator 304 and a bridge detector 320; however, for illustrative purposes, the local system 302A has X bridge generators 304(A) and Y bridge detectors 320(A), local system 302B has bridge generator 304(B) and bridge detector 320(B), and local system 302C has bridge generator 304(C) and bridge detector 320(C). For the purposes of this discussion, description and/or references to bridge generator 304 and/or bridge detector 320 can refer to either bridge generators 304, 304, 304 and/or bridge detectors 320, 320, 320, respectively.

In the exemplary system 400, local system 302A is coupled between local system 302B and local system 302C. Because of the coupling of local system 302A to local systems 302B and 302C, a detector on local system 302B can be notified of an event that occurred on local system 302C. The notification is accomplished by configuring each switch in the local systems 302 to route the event to a local system designed as the passthrough system. In the exemplary system 400, local system 302A is the passthrough local system such that an event generated in a connected local system can pass through local system 302 to another connected local system. In some examples, any of the local system 302 of system 400 can be the passthrough local system, and each of the other local systems 302 of system 400 are coupled to the passthrough local system via their respective bridge generators 304 and bridge detectors 320. In some examples, the system 400 can include any number of passthrough systems.

Each bridge generator 304 and bridge detector 320 is paired with a bridge detector 320 or bridge generator 304 in a connecting system. For example, as illustrated in FIG. 4, bridge generator 304(B) of local system 302B is paired to bridge detector 320(A)(1) of local system 302A, bridge generator 304(C) of local system 302C is paired to bridge detector 320(A)(Y) of local system 302A, bridge generator 304(A)(1) of local system 302A is paired to bridge detector 320(B) of local system 302B, bridge generator 304(A)(X) of local system 302A is paired to bridge detector 320(C) of local system 302C.

An event can occur in a local system for a detector not in a connected local system except through the passthrough local system. For example, generator 104(C)(1) in local system 302C generates an event for the detector 120(B)(1) in local system 302B. Accordingly, in this example, the event passes through system 400 via the dotted path illustrated in FIG. 4.

In the exemplary system 400, the switch 106C of the local systems 302C routes an event generated by generator 104(C)(1) of local system 302C to the bridge detector 320(C) of local system 302C. Specifically, the switch 106 of local system 302 determines that event identifier associated with the event does not correspond to any detector 120C of the local system 302C, and so the switch 106C of local system 302C broadcasts the event to bridge detector 320(C). The bridge detector 320(C) of local system 302C passes the event to the bridge generator 304(A)(X) of local system 302A because the bridge detector 320(C) of local system 302C and bridge generator 304(A)(X) of local system 302A are coupled together to communicate with each other. The local system 302A routes the event from bridge generator 304(A)(X) and through the switch 106A. Similar with switch 106C of local system 302C, the switch 106A of local system 302A determines that event identifier associated with the event does not correspond to any detector 120(A) of the local system 302A, and so the switch 106A of local system 302A broadcasts the event to the detectors coupled to switch 106A, including bridge detector 320(A)(1), and routes the event to the bridge detector 320(A)(1) via the event identifier of the event corresponding to the contents of the programmable register of the bridge detector 320(A)(1). The bridge detector 320(A)(1) passes the event to the bridge generator 304(B) of local system 302B. The local system 302B handles the event by routing the event from the bridge generator 304(B) and through the switch 106B.

At this point, the switch 106B of local system 302B determines that event identifier associated with the event does correspond to a detector 120(B)(1) of the local system 302B, and so the switch 106B of local system 302B broadcasts the event to the detector 120(B)(1), which is the intended target of the event generated by generator 104(C)(1) of local system 302C.

Using this concept, events can then be routed throughout the totality of the system even if the global system is changing at runtime. As long as each local system can be configured to route an event to a neighboring local system, any event can be routed from a generator in any local system to any detector in any local system. Accordingly, the present disclosure accomplishes the goal of routing events in a distributed system that is changing at runtime. The advantages of this approach to event routing are the resource efficiency as the system scales up and the ability to route events throughout the system, even if the global system is changed at runtime.

The cost that is associated with these advantages is the possibility of jitter. The switches can broadcast one event at a time. Broadcasting one event at a time is not a problem if events are only occurring one at a time. In this case, all events propagate from a local generator to a local detector in a deterministic amount of time. However, in a real system, events can occur at any time and have no timing relationship to one another. When two events occur at the same time, the events must still be broadcasted one at a time. Accordingly, the second event takes longer to propagate to its detector than the first event. This amount of propagation time changes based on how many events occurred at the same time, therefore introducing some possible jitter that is proportional to the amount of simultaneously occurring events. The amount of jitter that is introduced in most applications is within specification and not normally an issue. It is beneficial to clock the logic of the switches at a much faster rate than events are occurring to minimize the number of events that occur simultaneously with respect to the switch.

Aspects of the disclosure may operate on a particularly created hardware, on firmware, digital signal processors, or on a specially programmed general purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### EXAMPLES

Illustrative examples of the disclosed technologies are provided below. An embodiment of the technologies may include one or more, and any combination of, the examples described below.

Example 1 is a test and measurement device, comprising: one or more capture devices configured to receive an event from a respective event generator; a broadcaster configured to receive the event from the one or more capture devices and broadcast the event; and one or more comparators configured to receive the event from the batch broadcaster and route the event to a respective event detector based on a comparison of an event identifier and a detector identifier.

Example 2 is the test and measurement instrument of Example 1, wherein each of the one or more comparators comprises a programmable register configured to store an event identifier.

Example 3 is the test and measurement instrument of Example 2, wherein each event detector is configured to respond to a respective event generator; and each of the one or more comparators is coupled to a respective event detector and is configured to route the event to the respective event detector if the event identifier and the detector identifier matches.

Example 4 is the test and measurement instrument of any one of Example 1-3, wherein a number of the one or more capture devices is the same as a number of the generators.

Example 5 is the test and measurement instrument of any one of Example 1-4, wherein a number of the one or more comparators is the same as a number of the detectors.

Example 6 is the test and measurement instrument of any one of Example 1-5, wherein the broadcaster comprises a storage element for storing events received from the capture elements.

Example 7 is the test and measurement instrument of any one of Example 6, wherein the broadcaster is configured to batch incoming events while processing the event received from the event generator.

Example 8 is the test and measurement instrument of any one of Example 1-7, further comprising a capture device configured to receive an event from a first bridge generator, and a comparator configured to route the event to a bridge detector coupled to a second bridge generator.

Example 9 is the test and measurement instrument of any one of Example 1-8, wherein a clock speed of the device is greater than a rate of events received by the device.

Example 10 is a method for a test and measurement instrument, including a first set of generators configured to generate an event; a first set of detectors configured to respond to the event; and a first switch configured to route the event from the first set of generators to the first set of detectors. In Example 10, the first switch comprises a first set of capture devices configured to receive the event from the first set of generators; a batch broadcaster configured to batch the event received by the first set of capture devices, and broadcast the event; and one or more comparators configured to receive the broadcast from the batch broadcaster and transmit the event to the first set of detectors based on a comparison of an identifier corresponding to the event and a detector identifier.

Example 11 is the method of Example 10, wherein each of the one or more comparators comprises a programmable register configured to store the detector identifier corresponding to one of the first set of detectors associated with one of the generators.

Example 12 is the method of Example 10 or Example 11, further comprising: a first bridge generator coupled to an input of the first switch; a first bridge detector coupled to an output of the first switch; a second bridge generator configured to receive the event from the first bridge detector; a second bridge detector configured to receive the event from the second bridge generator; and a second switch, wherein the second bridge generator is coupled to an input of the second switch and the second bridge detector is coupled to an output of the second switch, and wherein the second switch is configured to route the event from the second bridge generator to the second bridge detector.

Example 13 is the method of any one of Example 10-12, further comprising: a first local system formed by the first set of detectors, the first set of generators, the first switch, the first bridge generator, and the first bridge detector; and a second local system formed by the second bridge generator, the second bridge detector, and the second switch.

Example 14 is the method of any one of Example 10-13, further comprising: a third bridge generator coupled to an input of the first switch; a third bridge detector coupled to an output of the first switch; a fourth bridge generator configured to receive the event from the third bridge detector; a fourth bridge detector configured to receive the event from the fourth bridge generator; and a third switch, wherein the fourth bridge generator is coupled to an input of the third switch and the fourth bridge detector is coupled to an output of the third switch, and wherein the third switch is configured to route the event from the fourth bridge generator to the fourth bridge detector.

Example 15 is the method of any one of Example 10-14, wherein the first switch comprises a faster clock speed compared to a rate of events occurring in the system.

Example 16 is the method of any one of Example 10-15, wherein a number of the events routed by the first switch is limited in a single clock cycle.

Example 17 is the method of any one of Example 10-16, wherein a number of detectors of the first set of detectors is the same as a number of generators of the first set of generators and each of the first set of detectors is configured to detect an event from a respective one of the first set of generators.

Example 18 is a method for a test and measurement instrument, including: capturing events as received from one or more event generators; broadcasting events to a one or more comparators, wherein each of the one or more comparators is configured to be coupled to a respective event detector; and routing the event to a detector based on a comparison of identifiers of captured events and a generator identifier for the corresponding event detector.

Example 19 is the test and measurement system of Example 18, wherein routing the event comprises comparing an event identifier of the event to contents of a programmable register coupled to the one or more comparators, and the contents of the programmable register comprises the generator identifier for the event detector coupled to a respective comparator.

Example 20 is the test and measurement system of Example 18 or Example 19, wherein the detector is a first bridge detector; the first bridge detector is coupled to a bridge generator and is configured to transmit the event to the bridge generator; the bridge generator is coupled to a switch, and is configured to receive the event from the first bridge detector; and the switch is configured to receive the event from the bridge generator and route the event to a second bridge detector.

Additionally, this written description makes reference to particular features. It is to be understood that the disclosure in this specification includes all possible combinations of those particular features. For example, where a particular feature is disclosed in the context of a particular aspect, that feature can also be used, to the extent possible, in the context of other aspects.

Also, when reference is made in this application to a method having two or more defined steps or operations, the defined steps or operations can be carried out in any order or simultaneously, unless the context excludes those possibilities.

Although specific aspects of the disclosure have been illustrated and described for purposes of illustration, it will be understood that various modifications may be made without departing from the spirit and scope of the disclosure.

What is claimed is:

1. A test and measurement device, comprising:
one or more capture devices configured to receive an event from a respective event generator;
a broadcaster configured to receive the event from the one or more capture devices and broadcast the event; and
one or more comparators configured to receive the event from the batch broadcaster and route the event to a respective event detector based on a comparison of an event identifier and a detector identifier.

2. The device of claim 1, wherein each of the one or more comparators comprises a programmable register configured to store an event identifier.

3. The device of claim 2, wherein:
each event detector is configured to respond to a respective event generator; and
each of the one or more comparators is coupled to a respective event detector and is configured to route the event to the respective event detector if the event identifier and the detector identifier matches.

4. The device of claim 1, wherein a number of the one or more capture devices is the same as a number of the generators.

5. The device of claim 1, wherein a number of the one or more comparators is the same as a number of the detectors.

6. The device of claim 1, wherein the broadcaster comprises a storage element for storing events received from the capture elements.

7. The device of claim 6, wherein the broadcaster is configured to batch incoming events while processing the event received from the event generator.

8. The device of claim 1, comprising a capture device configured to receive an event from a first bridge generator, and a comparator configured to route the event to a bridge detector coupled to a second bridge generator.

9. The device of claim 1, wherein a clock speed of the device is greater than a rate of events received by the device.

10. A test and measurement system, comprising:
a first set of generators configured to generate an event;
a first set of detectors configured to respond to the event; and
a first switch configured to route the event from the first set of generators to the first set of detectors, wherein the first switch comprises:
a first set of capture devices configured to receive the event from the first set of generators;
a batch broadcaster configured to batch the event received by the first set of capture devices, and broadcast the event; and
one or more comparators configured to receive the broadcast from the batch broadcaster and transmit the event to the first set of detectors based on a comparison of an identifier corresponding to the event and a detector identifier.

11. The system of claim 10, wherein each of the one or more comparators comprises a programmable register configured to store the detector identifier corresponding to one of the first set of detectors associated with one of the generators.

12. The system of claim 10, further comprising:
a first bridge generator coupled to an input of the first switch;
a first bridge detector coupled to an output of the first switch;
a second bridge generator configured to receive the event from the first bridge detector;
a second bridge detector configured to receive the event from the second bridge generator; and
a second switch, wherein the second bridge generator is coupled to an input of the second switch and the second bridge detector is coupled to an output of the second switch, and wherein the second switch is configured to route the event from the second bridge generator to the second bridge detector.

13. The system of claim 12, further comprising:
a first local system formed by the first set of detectors, the first set of generators, the first switch, the first bridge generator, and the first bridge detector; and
a second local system formed by the second bridge generator, the second bridge detector, and the second switch.

14. The system of claim 12, further comprising:
a third bridge generator coupled to an input of the first switch;
a third bridge detector coupled to an output of the first switch;
a fourth bridge generator configured to receive the event from the third bridge detector;
a fourth bridge detector configured to receive the event from the fourth bridge generator; and
a third switch, wherein the fourth bridge generator is coupled to an input of the third switch and the fourth bridge detector is coupled to an output of the third switch, and wherein the third switch is configured to route the event from the fourth bridge generator to the fourth bridge detector.

15. The system of claim 10, wherein the first switch comprises a faster clock speed compared to a rate of events occurring in the system.

16. The system of claim 10, wherein a number of the events routed by the first switch is limited in a single clock cycle.

17. The system of claim 10, wherein a number of detectors of the first set of detectors is the same as a number of generators of the first set of generators and each of the first set of detectors is configured to detect an event from a respective one of the first set of generators.

18. A test and measurement method comprising:
capturing events as received from one or more event generators;
broadcasting events to a one or more comparators, wherein each of the one or more comparators is configured to be coupled to a respective event detector; and
routing the event to a detector based on a comparison of identifiers of captured events and a generator identifier for the corresponding event detector.

19. The method of claim 18, wherein routing the event comprises comparing an event identifier of the event to contents of a programmable register coupled to the one or more comparators, and the contents of the programmable register comprises the generator identifier for the event detector coupled to a respective comparator.

20. The method of claim 18, wherein:
the detector is a first bridge detector,
the first bridge detector is coupled to a bridge generator and is configured to transmit the event to the bridge generator;
the bridge generator is coupled to a switch, and is configured to receive the event from the first bridge detector; and
the switch is configured to receive the event from the bridge generator and route the event to a second bridge detector.
